(19) United States
(12) Patent Application Publication
(10) Pub. No.: US 2021/0228023 A1
(43) Pub. Date: Jul. 29, 2021

(54) CONDUCTION OVEN SYSTEM WITH DOCKING STATION AND REMOVEABLE WARMING SHELF

(71) Applicant: Donald W. Wisner, Grand Haven, MI (US)

(72) Inventor: Donald W. Wisner, Grand Haven, MI (US)

(21) Appl. No.: 17/163,266

(22) Filed: Jan. 29, 2021

Related U.S. Application Data
(60) Provisional application No. 62/967,222, filed on Jan. 29, 2020.

(51) Int. Cl. A47J 37/06; A47J 36/24

(52) U.S. Cl. CPC A47J 37/0629; A47J 36/2483; A47J 37/0664

(57) ABSTRACT

A conduction oven system includes an oven enclosure operating as a docking station having removable warming shelf configured within the docking station where a wireless control system is used for controlling temperature and cook time of food products using the shelf. The warming shelf docks within the docking station and may use the same power source as the docking station or its own independent power source with the docking station acting as a charging station.

### FIELD OF THE INVENTION

The present invention relates generally to conduction ovens and more particular to a conduction oven having and removable warming shelf.

### BACKGROUND

A conduction oven uses a process where heat is transferred between objects through direct contact. Although crook pots and other types of conduction ovens are well known in the art, that are often bulky devices that sit on a countertop and consume space. Moreover, the food must remain in the oven until it is cooked and once removed no longer remains warmed. Consequently, new solutions are required when using conduction ovens for enabling them to offer more utility to the user.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A is a perspective view illustrating a conduction oven system having a docking station and removable warming shelf with the shelf inside the docking station according to an embodiment of the invention.

FIG. 1B is a perspective view illustrating a conduction oven system having a docking station and removable warming shelf with the shelf removed from the docking station.

FIG. 2A is front perspective view of the warming shelf operating as a hot trivet.

FIG. 2B is a rear perspective view of the warming shelf.

FIG. 3 is a block diagram illustrating the docketing station, warming shelf and wireless control thereof.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a fully automatic conduction oven system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

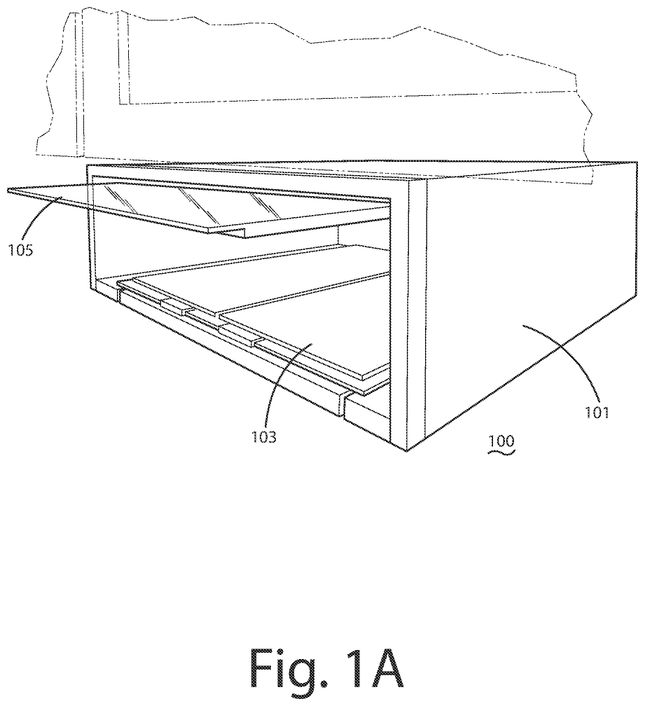

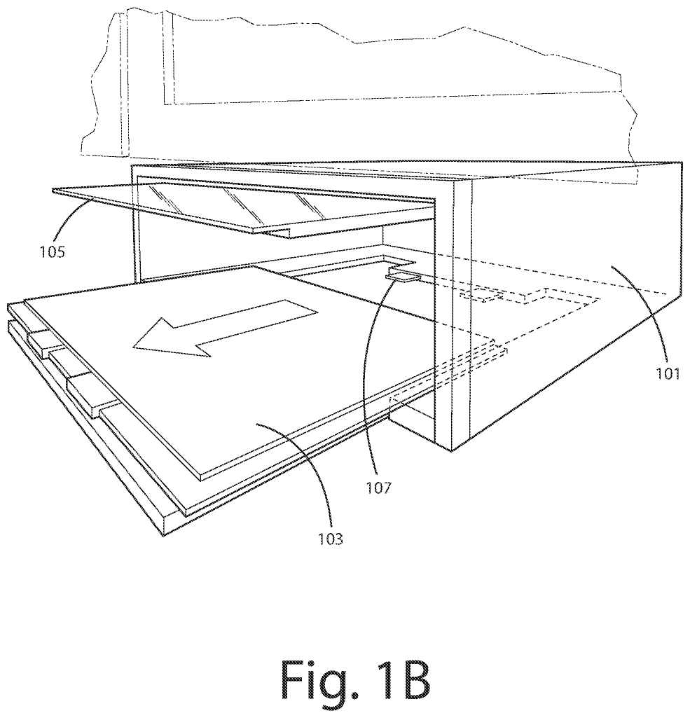

FIG. 1A and FIG. 1B are perspective views illustrating a conduction oven system having a docking station and removable warming shelf with the shelf inside the docking station and being removed from the docking station respectively. As seen in FIGS. 1A and 1B, the oven 100 is fully automatic and wirelessly controlled having no dials or buttons for controlling heating parameters. The conduction oven system 100 includes a housing 101 and having a warming shelf 103. Those skilled din the art will recognize that the warming shelf operates as a tray, plate, dish or platen that transfers heat to food items and/or containers placed on the warming shelf. This embodiment illustrates a single warming shelf 103 although a larger oven having other form factors with multiple warming shelves is also possible.

As seen in FIG. 1B the housing 101 works as a docking station and can be configured for table top or under-cabinet mounting. Those skilled in the art will recognize that the oven 100 and warming shelf 103 are sized so that it can accommodate a casserole dish or two single size containers. Although the oven 100 is intentionally illustrated having a low in profile, the oven 100 can also be constructed to be taller in size allowing it to hold larger food items such as a rotisserie chicken. The oven 100 includes a door 105 that can be closed to retain heat. The oven 100 includes its own power source operating on conventional 120 VAC, 12 VDC and/or USB-C. When inserted inside the oven, a first power source provides power to the warming shelf 103, like a docking station via electrical connectors 107. FIG. 1B illustrates the warming shelf 103 being removed from the housing 101. Once removed, the warming shelf 103 can be can be repowered by the first power source or alternately it can be independently powered using a second power source such as 120 VAC, 12 VDC, USB-C or a battery that integrates with the warming shelf 103.

In still other embodiments, the warming shelf 103 may include its own battery or self-contained power source mounted integrally with the warming shelf. In this instance, the housing 101 will not only operate as an oven but also as a charging station for the battery. When the warming shelf 103 is removed from the housing 101, it will remain powered to warm food since the battery is its primary source of power.

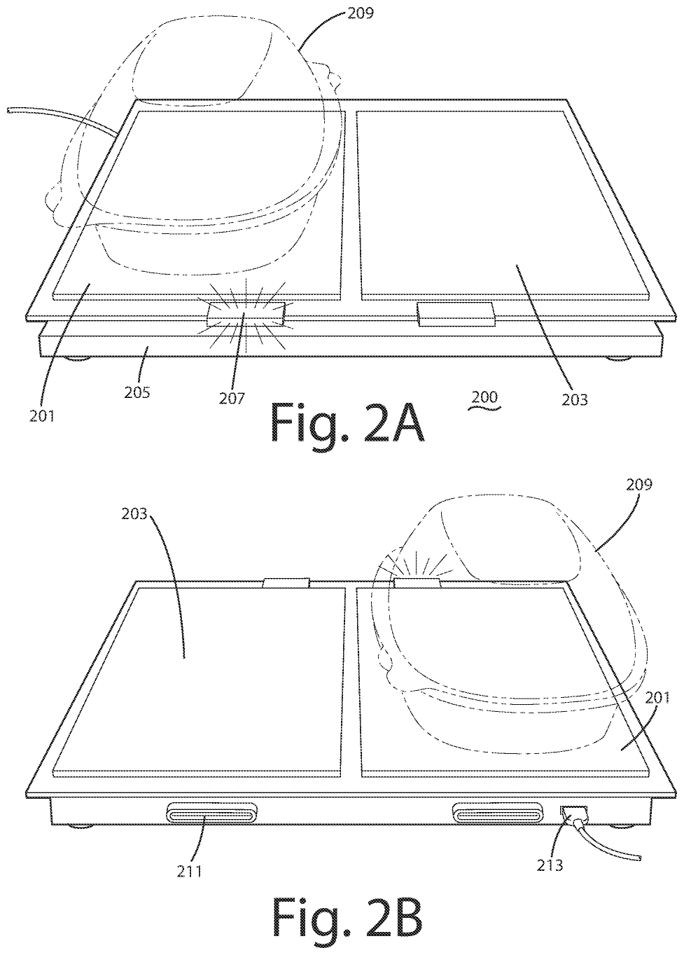

FIG. 2A and FIG. 2B are front and rear perspective views respectively of the warming shelf operating as a hot trivet. The warming shelf 200 bifurcated and includes a first warmer 201 on its left surface and a second warmer 203 on its right surface. Each of the first warmer 201 and second warmer 203 has it own feedback look for independently controlling temperature. The warming shelf 200 is configured upon a stand 205 so as not to damage a table top surface from the heat generated by the warming shelf. As seen in FIG. 2A, the first warmer 201 and second warmer each include an indicator light for annunciating to the user which portion of the warming shelf 200 is activated. FIG. 2A illustrates indicator light 207 illuminated with heat container 209 positioned on first warmer 201.

FIG. 2B shows the rear of the warming shelf 200, where a first power connector 211 is used by the oven to supply power thereto. A second power connector 213 operates to supply power to the warming shelf 200 when operating independently out of the oven as a hot trivet. In one embodiment, a battery is configured under the stand 205 to independently power the warming shelf 200 during its operation.

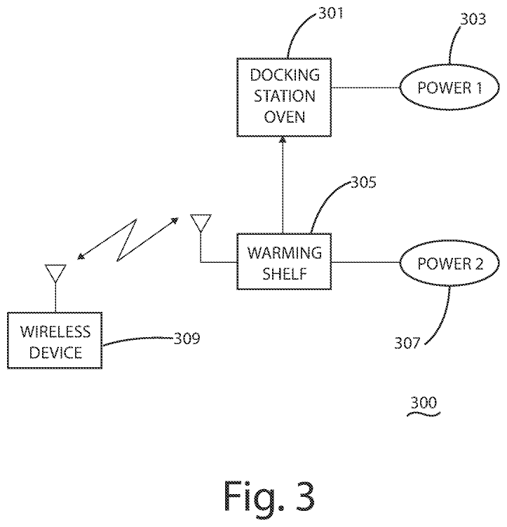

FIG. 3 is a block diagram illustrating the oven, warming shelf and wireless control thereof. The convection oven system 300 is shown where the oven docking station 301 includes a first power source 303 and warming shelf 305 includes a second power source 307. A wireless device 309 such as a cell phone, tablet or computer can wireless control operation of the warming shelf via a WiFi network, BlueTooth or the like.

Those skilled in the art will further recognize that a control system using a microprocessor is used in connection with each of the first warmer 201 and second warmer 203 for monitoring the operational parameters of the heating process. The oven 100 can monitor in real-time how a meal is reacting relative to the energy being added to the first warmer 201 and second warmer 203. The oven and its control system then dynamically adjust the energy input so that the energy that is used is minimal using only that which is needed. This allows the oven to perfectly cook a food item and/or meal in container 209. Thus, a major benefit of cooking with conduction type heat is that the food is thoroughly cooked yet never overcooked or dried out.

Further, when the meal reaches a predetermined serving temperature, an annunciation light and or sound will indicate that the item is ready to eat. At this time the control system automatically switches the warming shelf to a “hold” mode. In the hold mode, the control system works to maintain or hold a temperature of the completed meal for several hours without quality degradation.

In use, the warming shelf 200 is typically activated by detecting the temperature differential (ΔT) between a predetermined baseline temperature once a food item or container placed on the warming shelf. The warming shelf can detect and activate when items, such as container 209 is placed on the surface of the warming shelf. In other embodiments, a non-contact sensor is used which detects when a container is placed on the surface of the warming shelf.

Thus, in situations where the temperature of the food is warmer than the baseline temperature, the oven remains activated as a warming device enabling it to operate to keep food warm at some predetermined temperature. This type of oven activation works as a “dual-trigger” for ensuring the oven is activated to warm the food. This type of activation is particularly beneficial when using a food item like a partially cooked rotisserie chicken that is placed on a heated surface inside housing 101. In that situation, the chicken is already warmed and is at a higher temperature than the baseline temperature.

In this example, since the oven 100 includes a non-contact sensor, the warming shelf 201 will also be activated to cook and/or warm the food. Further, each warming surface can be independently controlled depending on the circumstances needed using WiFi/Bluetooth type control or messaging. This allows the warming shelf to act as a “smart shelf” that can be used in a buffet setting for holding the food items at a serving temperature. Alternatively, the warming shelf can be transferred to an insulated travel tote thus heating and holding the food at a hot temperature during transport with battery power.

In still yet another embodiment, the under-cabinet housing 101 is versatile allowing it to be removed from under a cabinet and used as a countertop device. More specifically, the warming shelf can be removed from the cabinet or housing 101 and used as a hot trivet. Thus in this mode, the oven has a great amount of utility since it can be used to both cook and/or hold food at a desired temperature. The warming self can also be placed in a transport container and/or connected to a power source to maintain a desired temperature. It can also be used to cook food in a portable carrier during transport and/or via an available power supply outside the designed housing 101. In these alternative embodiments, the housing works as a docking station. Thus, the warming shelf also serves to hold hot food at a hot temperature while functioning integral to the oven enclosure, transport container, or as a standalone heated trivet. Those skilled in the art will recognize that Wi-Fi control will allow temperature regulation outside of normal automatic mode.

Thus, the present invention is directed to an under-cabinet fully automatic conduction oven. The oven has no control dials or buttons for preventing the transmission of pathogens to other users. All that is required by the consumer is to load an item or meal and the control system in the conduction oven will perform all the required tasks. As noted herein, the oven has both Bluetooth and Wi-Fi interface capability allowing a full complement of user interface options via the use of a mobile phone or other electronic device. The mobile device will run an application used to activate and deactivate the device as well as annunciate timer expiration, notices or other warnings. The oven is further designed to trigger, though a predetermined temperature differential or the activation of, a non-contact sensor. In another embodiment, the warming shelf can slide out and be removed from the oven housing allowing the shelf to independently powered so to operate as a hot trivet. In other embodiments, it can also be placed in an insulated travel bag where the food remains warm for tailgating or transporting the food to some remote location.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A conduction oven system comprising:
an oven enclosure operating as a docking station for providing a first power source;
a removable warming shelf configured within the docking station;
a control system for controlling temperature of the removable warming shelf; and
wherein the removable shelf docks within the docking station for cooking food using the first power source and is removable for warming food outside the docking station using either the first power source or a second power source.

2. A conduction oven system as in claim 1, wherein the removable warming shelf includes at least two independent warming surfaces.

3. A conduction oven system as in claim 1, wherein the first power source is AC power and the second power source is either AC power, USB-C or a battery.

4. A conduction oven system as in claim 1 wherein the oven also acts as a charging station.

5. A conduction oven system as in claim 1, wherein the control system wirelessly controls the warming shelf.

6. A conduction oven system as in claim 2, wherein the battery integrates with the removable warming shelf.

7. A conduction oven system as in claim 1, wherein the warming shelf is activated using a control system that detects a difference in temperature of a food item on the warming shelf or through the detection of the food item placed on the warming shelf by at least one non-contact sensor.

8. A conduction oven system as in claim 1, wherein the removable shelf operates as a hot trivet.

9. A conduction oven system comprising:
a housing forming a docking station providing a first power source;
a warming shelf powered by the first power source when within the first docking station for use in cooking food; and
wherein the temperature of the warming shelf is wirelessly controlled and is removable from the docking station for keeping food warm using either the first power source or an independent second power source.

10. A conduction oven system as in claim 9, wherein the warming shelf includes at least two independent warming surfaces.

11. A conduction oven system as in claim 9, wherein the first power source is AC power and the second power source is either AC power, USB-C or a battery.

12. A conduction oven system as in claim 11, wherein the battery integrates with the removable warming shelf and the docking station acts as a charging station.

13. A conduction oven system as in claim 9, wherein the warming shelf is activated using a control system that detects a difference in temperature of a food item on the warming shelf or through the detection of the food item on the surface of the warming shelf by at least one non-contact sensor.

14. A conduction oven system as in claim 9, wherein the removable shelf operates as a hot trivet.

15. A conduction oven system comprising:
a housing forming an enclosed docking station powered by an AC power source;
a warming shelf configured within the docking station for cooking food;
a wireless control system for controlling the temperature of the warming shelf; and
wherein the warming shelf is removable from the docking station so to operate as a heated trivet powered by AC power, USB-C or a battery.

16. A conduction oven system as in claim 15, wherein the warming shelf includes at least two independent warming surfaces.

17. A conduction oven system as in claim 15, wherein the oven acts as a charging station for the warming shelf.

18. A conduction oven system as in claim 15, wherein the battery integrates into the removable warming shelf.

19. A conduction oven system as in claim 15, wherein the warming shelf is activated using a control system that detects a difference in temperature of a food item on the warming shelf or through the detection of the food item on the surface of the warming shelf by at least one non-contact sensor.
